(19) United States
(12) Patent Application Publication
(10) Pub. No.: US 2025/0031244 A1
(43) Pub. Date: Jan. 23, 2025

(54) Versatile Access Point Cooperation Setup

(71) Applicant: Telefonaktiebolaget LM Ericsson (publ), Stockholm (SE)

(72) Inventors: Charlie Pettersson, Solna (SE); Dennis Sundman, Sollentuna (SE); Sebastian Max, Cologne (DE); Jonas Sedin, Brentford, Greater London (GB); Rocco Di Taranto, Lund (SE)

(21) Appl. No.: 18/714,709

(22) PCT Filed: Dec. 10, 2021
(86) PCT No.: PCT/EP2021/085276

§ 371 Date: May 30, 2024

(51) Int. Cl. H04W 74/0808; H04W 88/08

(52) U.S. Cl. CPC H04W 74/0808; H04W 88/08

(57) ABSTRACT

An access point, AP, (10) of the wireless communication system determines a set of one or more cooperation schemes for cooperating with one or more further APs (10) of the wireless communication system. Further, the AP (10) determines a setup procedure for setting up cooperation among at least the AP (10) and the one or more further APs (10) based on a cooperation scheme selected from the set of one or more cooperation schemes. Further, the AP (10) sends a message of the setup procedure to the one or more further APs (10). The message indicates a further part of the setup procedure. Based on the setup procedure and the selected cooperation scheme, the AP (10) cooperates with at least one of the one or more further APs (10) in using a transmission opportunity, TXOP, on a wireless medium.

### TECHNICAL FIELD

The present invention relates to methods for controlling wireless transmissions and to corresponding devices, systems, and computer programs.

### BACKGROUND

In wireless communication technologies, there is an increased interest in using unlicensed bands, like the 2.4 GHz ISM band, the 5 GHz band, the 6 GHz band, and the 60 GHz band using more advanced channel access technologies. Historically, Wi-Fi has been the dominant standard in unlicensed bands when it comes to applications requiring support for high data rates. Due to the large available bandwidth in the unlicensed band, the WLAN (Wireless Local Area Network) technology based on the IEEE 802.11 standards family provides a very simple distributed channel access mechanism based on a so-called distributed coordination function (DCF).

Distributed channel access means that a device, in IEEE 802.11 terminology known as a station (STA), tries to access the wireless channel when it has data to send. Effectively there is no difference in channel access whether the station is an access point (AP) or a non-access point (non-AP). DCF works well as long as the load is not too high. When the load is high, and in particular when the number of stations trying to access the wireless channel is large, channel access based on DCF does not work well. The reason for this is that there will be a high probability of collision on the channel, leading to poor channel usage.

A default channel access mechanism used in current WLAN systems is referred to as enhanced distributed channel access (EDCA), as specified in IEEE Standard for Information technology-Telecommunications and information exchange between systems Local and metropolitan area networks-Specific requirements—Part 11: Wireless LAN Medium Access Control (MAC) and Physical Layer (PHY) Specifications,” in IEEE Std 802.11-2016 (Revision of IEEE Std 802.11-2012), vol., no., pp. 1-3534, 14 Dec. 2016, in the following denoted as “IEEE 802.11 Standard”. In the EDCA channel access mechanism, the STA accesses the channel using a set of channel access parameters based on a traffic class of the data. The wireless channel may be obtained for a time duration denoted as TXOP (transmit opportunity), in which multiple frames of the same data class may be transmitted. The maximum size of a TXOP depends on the data type. A typical duration of a TXOP is in the range of a few milliseconds.

To improve channel usage, and in particular to allow for better support of a large number of devices, a more centralized channel access may be utilized. Such centralized channel access may involve that rather than letting a STA access the channel whenever it has data to send, the channel access is controlled by the AP. A corresponding channel access scheme is for example supported in the IEEE 802.11ax technology, see IEEE 802.11ax-2021—IEEE Standard for Information technology—Telecommunications and information exchange between systems Local and metropolitan area networks-Specific requirements Part 11: Wireless LAN Medium Access Control (MAC) and Physical Layer (PHY) Specifications Amendment 1: Enhancements for High Efficiency WLAN (November 2019), in the following denoted as “IEEE 802.11ax amendment” or High Efficiency (HE) amendment. The IEEE 802.11ax technology, or HE technology, for example supports orthogonal frequency division multiple access (OFDMA) in both downlink (DL), i.e., in a direction from the AP to the STA, and uplink (UL), i.e., in a direction from the STA to the AP. Also multi-user (MU) transmission in form of multi-user multiple input multiple output (MU-MIMO) is supported for both the DL and the UL. By supporting MU transmission and letting the AP control the channel access within a cell, efficient channel usage is achieved and one can avoid collisions arising due to contention in the cell, in the IEEE 802.11 terminology also referred to as basic service set (BSS).

Coordinated operation of multiple APs is expected to further improve system performance. For example, multi-access point (MAP) coordination is considered as a candidate feature considered for the IEEE 802.11be technology, see IEEE P802.11be/D1.3 Draft Standard for Information technology—Telecommunications and information exchange between systems Local and metropolitan area networks-Specific requirements Part 11: Wireless LAN Medium Access Control (MAC) and Physical Layer (PHY) Specifications Amendment: Enhancements for Extremely High Throughput (November 2021), in the following denoted as “IEEE 802.11be Draft” or Extremely High Throughput (EHT) draft. MAP coordination assumes that a system performance can be improved if the APs within a limited area coordinate their transmissions instead of working independently. There are many approaches and proposals on how exactly the coordination among the APs can be implemented. For example, the following schemes are have been proposed: Coordinated Time Division Multiple Access (C-TDMA), Coordinated Orthogonal Frequency Division Multiple Access (C-OFDMA), Coordinated Spatial Reuse (CSR), Coordinated Beamforming (CBF), and Joint Transmission (JT). Within each of such schemes, there may be different variants of implementing the scheme.

C-TDMA and C-OFDMA are for example described in “Coordinated AP Time/Frequency Sharing in a Transmit Opportunity in 11be” (https://mentor.ieee.org/802.11/dcn/19/11-19-1582-02-00be-coordinated-ap-time-and-frequency-sharing-in-a-transmit-opportunity-in-11be.pptx, January 2020). As a general principle C-TDMA and C-OFDMA involve that several APs share either their time or frequency resources amongst each other. The medium access starts with one AP, typically termed as “sharing AP”, first winning contention for the wireless medium and reserving a TXOP on the wireless medium. Then the sharing AP invites one or more further AP(s), typically termed as “shared AP(s)”, to cooperate by sharing the same TXOP also for their transmissions. In the case of C-TDMA, this sharing is based on allocating different time resources to the APs. In the case of C-TDMA, the sharing involves allocating different frequency resources to the APs.

CSR is for example described in “Discussion on Coordinated Spatial Reuse Operation” (https://mentor.ieee.org/802.11/dcn/20/11-20-0457-01-00be-discussion-on-coordinated-spatial-reuse-operation.pptx, March 2020) or in “Coordinated Spatial Reuse: Focus on Downlink” (https://mentor.ieee.org/802.11/dcn/20/11-20-0590-05-00be-shared-txop-spatial-reuse-considerations.pptx, May 2020). In the case of CSR, APs may share a TXOP by allowing spatial reuse of resources of the TXOP by multiple, spatially separated transmissions. If the APs, and typically also their associated STAs, are sufficiently separated from each other, and mutual signal power shadowing conditions in the system allow for CSR, CSR may significantly increase system throughput. To enable the CSR, the APs may balance their transmit powers and/or take other measures to ensure that there is no excessive interference on the time/frequency resources of the TXOP. CSR may be based on spatial reuse features of the IEEE 802.11ax technology. In the IEEE 802.11ax technology, spatial reuse may involve allowing the AP to adjust its preamble detection threshold based upon what BSS a sent frame belonged to. Further, the IEEE 802.11ax technology enables simultaneous uplink transmissions by spatial reuse, based on a STA reading certain subfields in the header of an ongoing PPDU (Physical Protocol Data Unit). Based on the read subfields, the STA can ignore the ongoing transmission if it reduces its own transmit power. CBF may be regarded as an extension of CSR, making use of beamforming.

CBF may be used by APs equipped with multiple antennas. In the case of CBF, the APs may apply precoding matrices to steer the emitted power of their transmissions away from intended receivers of the other participating APs, which is also known as “placing nulls” at the intended receivers of the other participating APs. As compared to CSR, CBF can deliver a better signal-to-interference ratio of the simultaneous transmissions, which may in turn allow to further improve system capacity and/or to enable simultaneous transmissions in scenarios where CSR is not feasible. CBF typically requires the knowledge of up-to-date channel state information at the participating APs, e.g., as acquired by means of sounding frame exchanges. Such acquisition of channel state information may cause additional signaling overhead as compared to CSR.

JT involves transmission from two or more APs to the same STA in downlink or transmission from one STA to multiple APs in uplink. JT thus allows for using multiple, spatially separated transmission or reception points, thereby providing a further dimension of channel diversity. For downlink transmissions, multiple APs may form a multi-antenna array with large antenna separation. For uplink transmissions, the antennas of the different APs can be used for multi-antenna combining. The added diversity provided by JT can significantly increase system capacity. On the other hand, JT typically requires up-to-date channel state information, exchange of data between the participating APs, and precise synchronization between the participating APs. This may result in additional signaling overhead.

As can be seen, in wireless communication system with multiple APs multiple different schemes for cooperation among the APs can be available, without limitation to the above examples. Further, there may be different variants of each scheme. Each scheme and variant may have its own benefits or drawbacks, and choosing an appropriate scheme or variant may be challenging and may depend on the specific considered scenario and conditions.

Accordingly, there is a need for techniques which allow for efficiently managing cooperation of APs in situations where a plurality of different cooperation schemes are available.

### SUMMARY

According to an embodiment, a method of controlling wireless transmissions in a wireless communication system is provided. According to the method, an access point (AP) of the wireless communication system determines a set of one or more cooperation schemes for cooperating with one or more further APs of the wireless communication system. Further, the AP determines a setup procedure for setting up cooperation among at least the AP and the one or more further APs based on a cooperation scheme selected from the set of one or more cooperation schemes. Further, the AP sends a message of the setup procedure to the one or more further APs. The message indicates a further part of the setup procedure. Based on the setup procedure and the selected cooperation scheme, the AP cooperates with at least one of the one or more further APs in using a transmission opportunity (TXOP) on a wireless medium.

According to an embodiment, a method of controlling wireless transmissions in a wireless communication system is provided. According to the method, an AP of the wireless communication system receives, from a further AP, a message of a setup procedure for setting up cooperation among at least the AP and the further AP based on a cooperation scheme selected from a set of one or more cooperation schemes. The message indicates a further part of the setup procedure. Based on the setup procedure and the selected cooperation scheme, the AP cooperating at least with the further AP in using a TXOP on a wireless medium.

According to a further embodiment, an AP for a wireless communication system is provided. The AP is configured to determine a set of one or more cooperation schemes for cooperating with one or more further APs of the wireless communication system. Further, the AP is configured to determine a setup procedure for setting up cooperation based on a cooperation scheme selected from the set of one or more cooperation schemes. Further, the AP is configured to send a message of the setup procedure to the one or more further APs. The message indicates a further part of the setup procedure. Further, the AP is configured to, based on the setup procedure and the selected cooperation scheme, cooperate with at least one of the one or more further access points in using a TXOP on a wireless medium.

According to a further embodiment, an AP for a wireless communication system is provided. The AP comprises at least one processor and a memory. The memory contains instructions executable by said at least one processor, whereby the AP is operative to determine a set of one or more cooperation schemes for cooperating with one or more further APs of the wireless communication system. Further, the memory contains instructions executable by said at least one processor, whereby the AP is operative to determine a setup procedure for setting up cooperation based on a cooperation scheme selected from the set of one or more cooperation schemes. Further, the memory contains instructions executable by said at least one processor, whereby the AP is operative to send a message of the setup procedure to the one or more further APs. The message indicates a further part of the setup procedure. Further, the memory contains instructions executable by said at least one processor, whereby the AP is operative to, based on the setup procedure and the selected cooperation scheme, cooperate with at least one of the one or more further access points in using a TXOP on a wireless medium.

According to a further embodiment, an AP for a wireless communication system is provided. The AP is configured to receive, from a further AP, a message of a setup procedure for setting up cooperation among at least the AP and the further AP based on a cooperation scheme selected from a set of one or more cooperation schemes. The message indicates a further part of the setup procedure. Further, the AP is configured to, based on the setup procedure and the selected cooperation scheme, cooperate at least with the further access point in using a TXOP on a wireless medium.

According to a further embodiment, an AP for a wireless communication system is provided. The AP comprises at least one processor and a memory. The memory contains instructions executable by said at least one processor, whereby the AP is operative to receive, from a further AP, a message of a setup procedure for setting up cooperation among at least the AP and the further AP based on a cooperation scheme selected from a set of one or more cooperation schemes. The message indicates a further part of the setup procedure. Further, the memory contains instructions executable by said at least one processor, whereby the AP is operative to, based on the setup procedure and the selected cooperation scheme, cooperate at least with the further access point in using a TXOP on a wireless medium.

According to a further embodiment, a computer program or computer program product is provided, e.g., in the form of a non-transitory storage medium, which comprises program code to be executed by at least one processor of a AP is provided. Execution of the program code causes the AP to determine a set of one or more cooperation schemes for cooperating with one or more further APs of the wireless communication system. Further, execution of the program code causes the AP to determine a setup procedure for setting up cooperation based on a cooperation scheme selected from the set of one or more cooperation schemes. Further, execution of the program code causes the AP to send a message of the setup procedure to the one or more further APs. The message indicates a further part of the setup procedure. Further, execution of the program code causes the AP to, based on the setup procedure and the selected cooperation scheme, cooperate with at least one of the one or more further access points in using a TXOP on a wireless medium.

According to a further embodiment, a computer program or computer program product is provided, e.g., in the form of a non-transitory storage medium, which comprises program code to be executed by at least one processor of a AP is provided. Execution of the program code causes the AP to receive, from a further AP, a message of a setup procedure for setting up cooperation among at least the AP and the further AP based on a cooperation scheme selected from a set of one or more cooperation schemes. The message indicates a further part of the setup procedure. Further, execution of the program code causes the AP to, based on the setup procedure and the selected cooperation scheme, cooperate at least with the further access point in using a TXOP on a wireless medium.

Details of such embodiments and further embodiments will be apparent from the following detailed description.

### BRIEF DESCRIPTION OF THE DRAWINGS

FIG. 1 schematically illustrates an example of phases in a procedure for coordinated use of a TXOP by multiple APs.

FIG. 2 schematically illustrates a wireless communication system according to an embodiment.

FIG. 3 schematically illustrates a MAP coordination request according to an embodiment.

FIG. 4 schematically illustrates a MAP coordination response according to an embodiment.

FIG. 5 schematically illustrates a MAP coordination user indication according to an embodiment.

FIG. 6 schematically illustrates an example of a procedure to be implemented by a sharing AP in MAP coordination according to an embodiment.

FIG. 7 schematically illustrates an example of a procedure to be implemented by a shared AP in MAP coordination according to an embodiment.

FIGS. 8A, 8B, and 8C schematically illustrate examples of MAP coordination processes according to embodiments.

FIG. 9 shows a flowchart for schematically illustrating a method according to an embodiment.

FIG. 10 shows a block diagram for schematically illustrating functionalities of an AP according to an embodiment.

FIG. 11 shows a flowchart for schematically illustrating a further method according to an embodiment.

FIG. 12 shows a block diagram for schematically illustrating functionalities of a further AP according to an embodiment.

FIG. 13 schematically illustrates structures of an AP according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN (Wireless Local Area Network) system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project).

According to the illustrated concepts, an access point (AP) of the wireless communication system may cooperate with one or more further APs of the wireless communication system. The cooperation is in the following also denoted as MAP (multi-access point) cooperation. This cooperation is based on a cooperation scheme selected by one of the APs and a setup procedure which can flexibly support different possible cooperation schemes. Depending on the cooperation scheme, the setup procedure involves an exchange of one or more messages between the AP and the further APs. One message, e.g., a first message sent by the AP, indicates a further part of the setup procedure, e.g., by indicating whether the AP expects a response to this message or a number of messages to be transmitted in the further course of the setup procedure. The message may also indicate the selected cooperation scheme or one or more suggested cooperation schemes. Similarly, a message received from the further AP(s) may indicate the selected cooperation scheme or one or more suggested cooperation schemes. Accordingly, the setup procedure may be used for negotiating the cooperation scheme to be selected with the further AP(s).

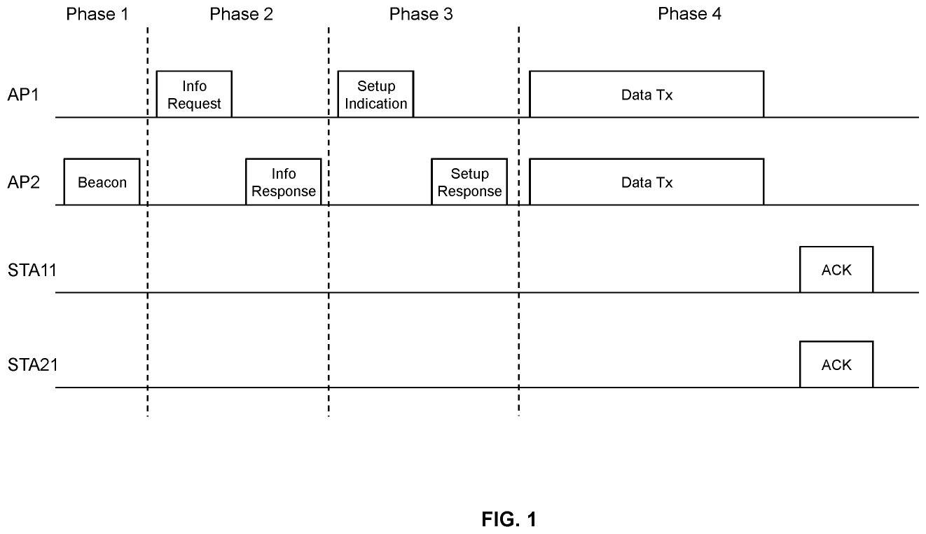

FIG. 1 schematically illustrates an example of possible phases of cooperation among multiple APs. Here, it is noted that, depending on the specific cooperation scheme to be utilized, some of these phases could also be omitted or be implemented in a different way. FIG. 1 illustrates phases which include a first phase (“Phase 1”) for capability exchange, a second phase (“Phase 2”) for BSS information collection, a third phase (“Phase 3”) for cooperation setup, and a fourth phase (“Phase 4”) for execution of the cooperation, e.g., by sharing a TXOP.

In the first phase, nearby APs can signal to each other various capability information, including capability information relevant for MAP cooperation. The exchanged capability information may for example include information on one or more cooperation schemes supported by an AP and/or on possible variants of such cooperation schemes. Further, the exchanged capability information may indicate hardware capabilities of an AP, such as number of antennas, minimum and maximum transmit power, supported data rates, or the like. The exchange of capability information can be based on beacon frames broadcasted by the APs. For example, the beacon frames could be supplemented by an information element for indicating MAP cooperation capability information.

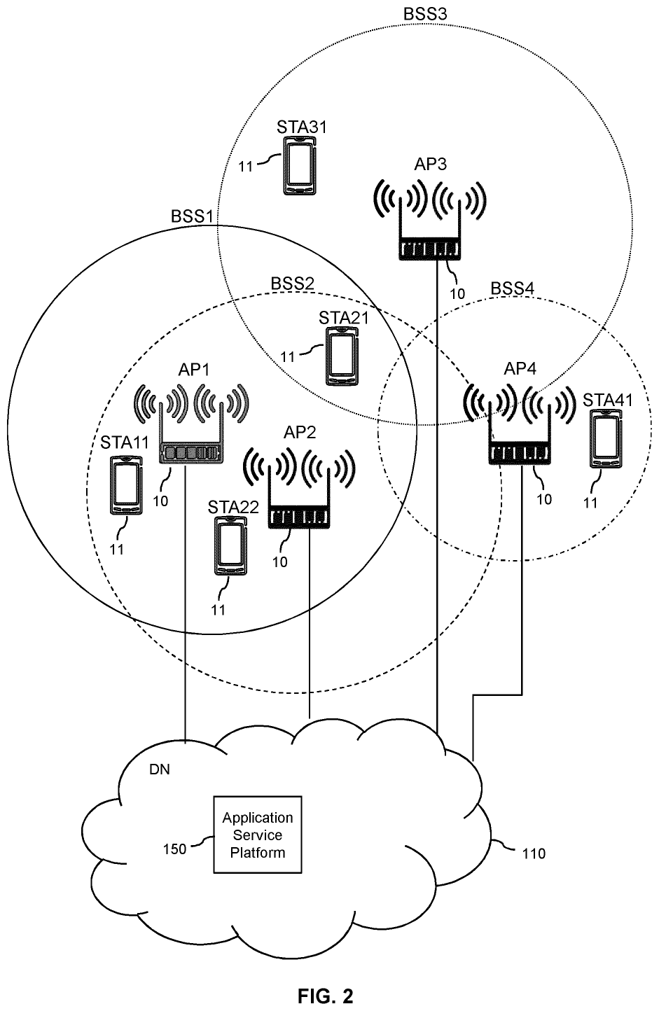

The second phase may be used for collecting various BSS information relevant for MAP cooperation. Typically, such BSS information is needed in any cooperation scheme. However, the nature of the needed BSS information and/or way of collecting the BSS information may vary depending on the cooperation scheme to be utilized. In some cases, existing measurement procedures may be used for collecting at least a part of the BSS information. It is noted that the timing of the second phase illustrated in FIG. 2 is merely an example. The timing of collecting the BSS information relative to the other phases may vary, e.g., concerning the timescale of collecting the BSS information. Such timescale typically depends on how up-to date the collected BSS information needs to be. For example, in order to perform CSR the collected BSS information could include an RSSI (Received Signal Strength Indicator) measured by non-AP STAs of other APs. Such RSSI typically has only little variation overtime, so that corresponding BSS information does not need to be collected very frequently.

In the third phase, the actual setup of MAP cooperation may be performed. Depending on the cooperation scheme to be utilized, the third phase may include a transmission of typically one to four messages. For example, in the case of CSR the third phase may consist of only a single message from the AP which allows the CSR of certain resources. In the case of C-OFDMA, the third phase may consist of four messages.

In the fourth phase, MAP cooperation is executed by two or more of the APs. This typically involves data transmission (Data Tx) and transmission of acknowledgement (ACK) feedback. The way of executing the MAP cooperation and/or the APs participating in the MAP cooperation depends on the information determined in the earlier phases. For example, if the cooperation scheme corresponds to CSR for downlink transmissions, the fourth phase may include that the participating APs set appropriate power levels to ensure simultaneous transmissions without excessive interference. In the case of JT, the fourth phase may include that the participating APs collectively perform a sounding phase to enable preprocessing of the jointly transmitted signals.

FIG. 2 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA21, STA22, STA31, and STA41. STA11 is served by AP1 (in a first BSS denoted as BSS1), STA21 and STA22 are served by AP2 (in a second BSS denoted as BSS2), STA31 is served by AP3 (in a third BSS denoted as BSS3), and STA41 is served by AP4 (in a fourth BSS denoted as BSS4). The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 2, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed band like the 2.4 GHz ISM band, the 5 GHz band, the 6 GHz band, or the 60 GHz band.

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 2 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

To achieve high performance in wireless systems with multiple overlapping cells or BSSs, e.g., in a scenario like illustrated in FIG. 2, some kind of coordination between the cells or BSSs may be used. As an example, two or more APs, such as the APs 10 of FIG. 2, may contend for the channel in order to obtain a TXOP. Then, the winning AP can share the resources with the other contending APs in a dynamic fashion, i.e., it can share the TXOP. As used herein, sharing of the TXOP involves that the TXOP can be used by at least two different transmitters at the same time. In the illustrated concepts, the coordination is based on a cooperation scheme selected by one of the APs and a setup procedure which can flexibly support different possible cooperation schemes. Such cooperation schemes may include, without limitation, C-TDMA, C-OFDMA, CSR, CBF, and JT. The cooperation is based on a setup procedure which can flexibly support such different cooperation schemes and variants thereof. For example, the number of messages transmitted in the course of the setup procedure may vary depending on the cooperation scheme or variant of cooperation scheme to be utilized. Further, the cooperation scheme or variant of cooperation scheme may be selected in the course of the setup procedure. The selection may be based on information collected from one or more messages transmitted in the setup procedure. In the following, the cooperation of multiple APs based on such versatile setup procedure will be explained in more detail. In these explanations, the messages of the setup procedure will also be referred to as “setup frames”. For example, such setup frames could be specific types of control frames as specified for the IEEE 802.11 technology. Further, the following examples assume that the cooperation is based on sharing of a TXOP, i.e., that one AP wins contention for the wireless medium, reserves a TXOP on the wireless medium, and then shares the TXOP with one or more other APs. The AP winning the contention is also denoted as “sharing AP” and the other APs are also denoted as “shared AP”. In many cooperation schemes, the cooperation involves that the sharing AP allows the shared AP(s) to use resources of the TXOP reserved by the sharing AP for transmission in their own BSS. It is however noted that in some cooperation schemes the cooperation could also involve that one or more other APs assist the AP which reserved the TXOP in transmission in the BSS of the AP which reserved the TXOP. JT is an example of such cooperation scheme.

In the illustrated examples, a sharing AP may decide which cooperation scheme shall be used for a given TXOP. For this purpose, the sharing AP may collect information from potential shared APs. The sharing AP may also collect information which is relevant for multiple cooperation schemes, and such information may be used to weigh different cooperation schemes against each other. Accordingly, in the setup procedure the sharing AP may indicate to potential shared AP(s) what potential cooperation scheme(s) shall be considered for the upcoming cooperation. Further, the sharing AP may indicate to potential shared AP(s) if the sharing AP is interested in feedback from the potential shared AP(s) on such potential cooperation schemes. Further, the sharing AP may indicate to potential shared AP(s) how many setup frames are needed before execution of cooperation can start based on the selected cooperation scheme. Further, the sharing AP may indicate to potential shared APs whether the selected cooperation scheme will be used for downlink transmissions, uplink transmissions, or both downlink and uplink transmissions.

As mentioned above, the number of setup frames in the setup procedure may vary depending on the cooperation scheme or variant which is actually utilized. By having fewer setup frames, signaling overhead can be reduced. On the other hand, a certain number of setup frames may be needed to provide the APs with information which is required or at least beneficial for execution of the cooperation. For example, the sharing AP could be provided with feedback from the potential shared APs that enables the sharing AP to take a more informed decision on selection of the cooperation scheme to be utilized. For example, a setup procedure that consists of one or two setup frames exchanged between the APs could result in a suboptimal selection of the cooperation scheme or suboptimal setting of transmission parameters for the TXOP. As compared to that, a setup procedure that consists of three, four, or more setup frames exchanged between the APs can enable the sharing AP to make a more informed decision on transmission parameters. Accordingly, in some scenarios the sharing AP may decide how many setup frames shall be exchanged, depending on the level of information needed by the sharing AP. For example, the sharing AP could decide to use a setup procedure with three setup frames for a first TXOP and then to use a setup procedure with only one setup frame for subsequent TXOPs. For such subsequent TXOPs the sharing AP could reuse information collected in the setup procedure for the first TXOP. In some scenarios, the number of frames to be exchanged in the setup procedure could also depend on traffic requirements at the sharing AP, e.g., by reducing the number of setup frames in the case of more relaxed traffic requirements. In some scenarios, the number of frames to be exchanged in the setup procedure could also depend on load in the wireless communication system, e.g., a traffic load of the sharing AP and its neighboring APs.

It is noted that selecting an appropriate cooperation scheme from multiple available cooperation schemes may be a non-trivial task. Such selection may be based on various criteria. The selection could be performed by the sharing AP alone or collectively by the sharing AP and the potential shared AP(s), e.g., based on a negotiation mechanism. Criteria which can be considered in the selection are capabilities of the sharing AP, and/or capabilities of the potential shared AP(s). Thus, some factors that could influence this decision are, e.g., the capabilities of the sharing AP. If the capabilities of the sharing AP supports a single cooperation scheme, the sharing AP can indicate this cooperation scheme to the potential shared AP. If the capabilities of the sharing AP support a set of multiple cooperation schemes, the sharing AP could select one cooperation scheme from this set and indicate the selected cooperation scheme to the potential shared AP(s). Alternatively, the sharing AP could indicate all cooperation schemes of the set, or a selected subset of the cooperation schemes from the set, to the potential shared APs and ask the potential shared AP(s) for feedback on these indicated cooperation schemes. Such feedback may be based on capabilities of the potential shared AP(s), e.g., by indicating which of the indicated cooperation schemes is also supported by the capabilities of the respective potential shared AP. In addition or as an alternative, such feedback could be based on traffic requirements at the respective potential shared AP. For example, if the potential shared AP has rather relaxed traffic requirements, the feedback could indicate a less elaborate cooperation scheme.

When a potential shared AP receives a setup frame from the sharing AP, the potential shared AP may decide whether to continue the setup procedure, to start execution of the cooperation, or to not participate in the cooperation. In the latter case, the potential shared AP may implement such refusal in different ways, also depending on the setup frame received from the sharing AP. For example, if the setup frame received from the sharing AP was directed to a group of potential shared APs, the potential shared AP(s) which decides to refuse participation could indicate the refusal by not replying to the setup frame from the sharing AP. If the setup frame from the sharing AP was directed to only a specific potential shared AP, this AP could reply with a setup frame which indicates the refusal. This may be accomplished in such a way that the sharing AP will not lose the access to the wireless medium, e.g., because another device detects a long period of no transmissions on the wireless medium due to the reply from the potential shared AP being too late or not being sent at all. At the potential shared AP, the decision to refuse participation can for example be due to not supporting the cooperation scheme or variant indicated by the sharing AP. Another reason for the refusal could be that the potential shared AP does not have downlink or uplink data pending for transmission. In some scenarios, the potential shared AP could also indicate the reason of the refusal to the sharing AP.

At least some of the setup frames of the setup procedure may be based on a flexible frame structure. Such flexible frame structure may allow for efficiently addressing the individual requirements of the different possible cooperation schemes and variants of such cooperation schemes. An example of such flexible frame structure will be further explained in the following. In this example, it is assumed that three different types of setup frames are available in the setup procedure: a MAP coordination request frame, a MAP coordination response frame, and a MAP coordination user indication frame.

The MAP coordination request frame is sent from the sharing AP to the potential shared AP(s). It has the purpose of indicating that the sharing AP intends to start cooperation with the potential shared AP(s). The MAP coordination request frame can also indicate that the sharing AP requires feedback from the potential shared AP(s), e.g., feedback on specific transmission parameters to be used in a certain cooperation scheme.

The MAP coordination response frame is sent from the potential shared AP(s) to the sharing AP. The MAP coordination response frame may be sent in a conditional manner, only if the sharing AP has indicated that it wants feedback from the potential shared AP(s).

The MAP coordination user indication frame can be sent by both the sharing AP and the potential shared AP(s) to their respective associated STAs, which were chosen to participate in the cooperation based on a specific cooperation scheme. In the MAP coordination user indication frame the APs can transmit various information that is relevant or beneficial to the STAs when executing the cooperation.

The above-mentioned setup frames may be composed in a dynamic manner, depending on the actual requirements of the setup procedure. In particular, the setup frames may include various information fields, and the presence and/or size of such information fields may be adapted by the AP sending the message, to accommodate for the needs of the particular cooperation scheme(s) considered. The specific information fields discussed below are to be considered as explanatory examples provided in the context of TXOP sharing. Other types of information fields could be used in addition or as an alternative.

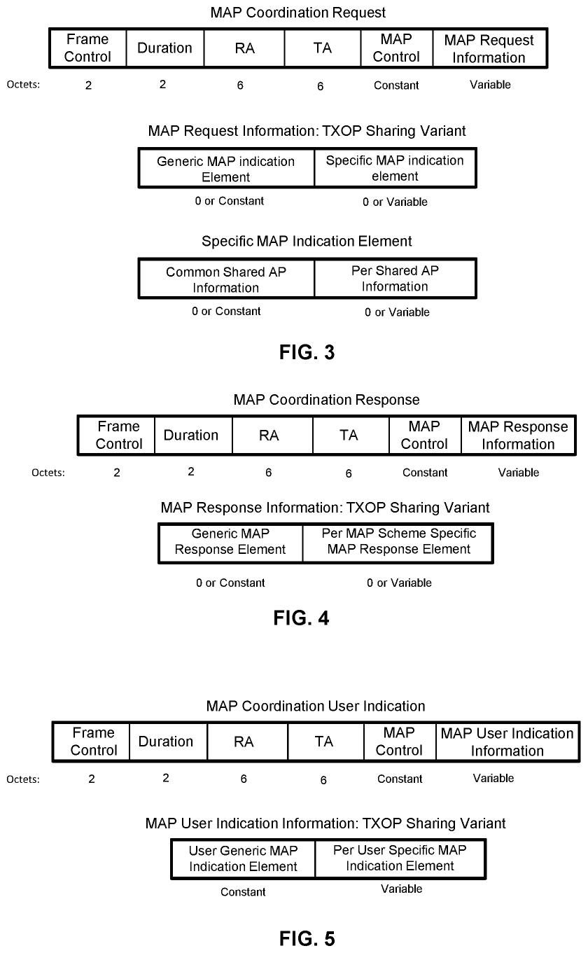

FIG. 3 schematically illustrates an exemplary format of the MAP coordination request frame, FIG. 4 schematically illustrates an exemplary format of the MAP coordination response frame, and FIG. 5 schematically illustrates an exemplary format of the MAP coordination user indication frame. As can be seen, these exemplary formats are each based on the MAC control frame format of the IEEE 802.11 Standard and thus include a frame control field, a duration field, a receiving address (RA) field, and a transmitting address (TA) field. Further, each of the exemplary formats includes a MAP control field.

The MAP control field is used to indicate one or more cooperation schemes supported by the AP transmitting the setup frame. The MAP control field may be a bit map of constant size, with each bit position corresponding to a specific cooperation scheme. The mapping of cooperation schemes to bit positions may be pre-configured in the APs, e.g., based on standardization, or could at least in part be configurable, e.g., by operator settings. Based on the MAP control fields of the setup frames, the APs exchanging the setup frames may thus learn what cooperation schemes are supported by the respective other APs. The usage of the MAP control field may differ between the types of setup frames: In the MAP coordination request frame the sharing AP may use the MAP control field to indicate a subset of those cooperation schemes which are available, e.g., as determined from an initial capability exchange in beacon frames. The selection of the subset may for example be based on traffic requirements at the sharing AP. The subset may include multiple cooperation schemes to be used as a basis for further selection based on feedback from the potential shared APs. If the sharing AP decides that a specific cooperation scheme is to be utilized, the subset may also include only one cooperation scheme.

In the MAP coordination response frame, the potential shared AP may use the MAP control field to indicate the feedback for the supported cooperation schemes indicated by the sharing AP. The cooperation schemes indicated in the MAP control field of the MAP coordination response frame may thus correspond to those indicated by the sharing AP or to a subset of those indicated by the sharing AP. The subset indicated in the MAP coordination response frame may depend on the capabilities of the potential shared AP and/or on the traffic requirements at the potential shared AP or other preferences of the potential shared AP. In the MAP coordination user indication frame, the sharing AP or the shared AP may use the MAP control field to indicate the cooperation scheme to be utilized to the respective associated STAs. The cooperation scheme to be utilized may have been selected by the sharing AP and be indicated by the sharing AP in a specific MAP indication element of a MAP coordination request frame.

As further illustrated, the exemplary formats of the different setup frame types include information fields which are specific to the respective setup frame type. These information fields will be further explained in the following.

As illustrated in FIG. 3, the MAP coordination request frame includes MAP request information which, at least in the case of cooperation by TXOP sharing, includes a generic MAP indication element and a specific MAP information element.

The generic MAP indication element includes information, provided from the sharing AP to the potential shared AP(s), that is common to multiple cooperation schemes. The generic MAP indication element could be provided in every MAP coordination request frame or only in an initial MAP coordination request frame of the setup procedure. In other words, in some scenarios the setup procedure could involve that the sharing AP sends a first MAP coordination request frame and subsequently two or more further MAP coordination request frames, and the generic MAP indication element is included only in the first MAP coordination request frame.

Information indicated in the generic MAP indication element may include one or more of: an indication of time duration of the TXOP, an indication of invited shared APs from an AP candidate set, an indication of a number of transmit antennas to be utilized, an indication of whether the sharing AP intends to utilize cooperation for downlink transmissions, uplink transmission, or both downlink and uplink transmissions, a query whether the potential shared AP prefers to utilize cooperation for downlink transmissions, uplink transmission, or both downlink and uplink transmissions. Further, the generic MAP indication element may include an indication whether a MAP coordination response from the potential shared APs is required and/or an indication which information elements are required in such MAP coordination response. Further, the generic MAP indication element may include an indication whether the potential shared AP(s) may disregard providing feedback for a cooperation scheme they are not interested to participate in. Further, the generic MAP indication element may include an indication on how up-to-date information needs to be in order to be considered in the cooperation. Further, the generic MAP indication element may include an indication of a number of specific MAP indication elements in the MAP coordination request frame.

The specific MAP indication element includes information that relates to the cooperation scheme selected to be utilized and is not already included in the generic MAP indication element. The content of the specific MAP indication element may thus vary depending on the cooperation scheme to be utilized. The information included in the specific MAP indication element may for example include transmit parameters or relate to specific protocol aspects. The specific MAP indication element may include a common part with information that is common to all shared APs and a specific part that includes information that may differ between at least some of the shared APs and is thus indicated individually per shared AP. Providing the specific MAP indication element in the MAP coordination request frame is optional. The specific MAP indication element may be included in a MAP coordination request frame when the sharing AP has decided on which cooperation scheme shall be utilized for the TXOP. To identify the cooperation scheme to be utilized, the specific MAP indication element may include a cooperation scheme identifier of the cooperation scheme.

As illustrated in FIG. 4, the MAP coordination response frame includes MAP response information which, at least in the case of cooperation by TXOP sharing, includes a generic MAP response element and a specific MAP response element. The generic MAP response element could be provided in every MAP coordination response frame or only in an initial MAP coordination response frame from a certain potential shared AP. In other words, in some scenarios the setup procedure could involve that the potential shared AP sends a first MAP coordination response frame and subsequently two or more further MAP coordination response frames, and the generic MAP indication element is included only in the first MAP coordination response frame. It is however noted that in many scenarios only one MAP coordination response frame from a given potential shared AP is actually needed and optimization of the setup procedure may involve avoiding transmission of additional MAP coordination response frames.

The generic MAP response element includes information, provided from the potential shared AP back to the sharing AP, that is common to multiple cooperation schemes. Information indicated in the generic MAP response element may include one or more of: an indication of one or more preferred cooperation schemes among those indicated by the sharing AP, an indication of a buffer status for downlink transmissions from the potential shared AP, an indication of a buffer status for uplink transmissions to the potential shared AP. The information on buffer status may for example include an indication that the buffer is empty and/or or an access category (AC) associated with the buffer. In some cases, such indication that a buffer relevant to a cooperation scheme is empty could also be implicit from the MAP coordination response frame. Further, the generic MAP response element may include an indication of a number of specific MAP response elements in the MAP coordination response frame. Further, the potential shared AP can include in the specific MAP response element an indication whether it prefers to cooperate in cooperation for downlink transmissions, uplink transmissions, or both downlink and uplink transmissions.

The specific MAP response element includes information that relates to a specific cooperation scheme and is not yet included in the generic MAP response element. The content of the specific MAP indication element may thus vary depending on the cooperation scheme being considered. An individual specific MAP response element may be provided for each cooperation scheme requiring feedback to the sharing AP, e.g., as indicated in the MAP coordination request frame. The user specific MAP response element may identify the cooperation scheme to which it relates. For this purpose, the user specific MAP indication element may include a cooperation scheme identifier of the cooperation scheme. In some cases, the potential shared AP may refrain from providing a specific MAP response element for a cooperation scheme not supported by the potential shared AP, e.g., because it does not have the capability to participate in this cooperation scheme. Further, if the potential shared AP in principle has the capabilities to participate in a certain cooperation scheme, but is not sufficiently prepared to do so, e.g., due to not having collected information required to participate, the potential shared AP can include in the specific MAP response element an indication that will not or cannot participate in that cooperation scheme, optionally supplemented by an indication of a reason for this decision. Further, the potential shared AP may use the specific MAP response element to indicate that it has not collected sufficient information to participate in that cooperation scheme or that the collected information is not up-to-date. For some cooperation schemes, the information included in the specific MAP response element may for example include BSS information of the potential shared AP, such as RSSIs of other APs as measured by non-AP STAs associated to the potential shared AP. The latter information can for example be useful for a cooperation scheme involving CSR.

As illustrated in FIG. 5, the MAP coordination user indication includes MAP user indication information which, at least in the case of cooperation by TXOP sharing, includes a user generic MAP indication element and a user specific MAP indication element.

The user generic MAP indication element may be used by the sharing AP or the shared AP to indicate, to the associated non-AP STAs, information which is relevant to the selected cooperation scheme to be utilized and is common for all the non-AP STAs. Such information may include one or more of: an indication of the time duration of the TXOP, an indication of whether the cooperation is for downlink transmissions, uplink transmissions, or both uplink and downlink transmissions. Further, the user generic MAP indication element may include an indication of a number of user specific MAP indication elements included in the MAP coordination user indication frame.

The user specific MAP indication element includes information that relates to the cooperation scheme selected to be utilized and is not already included in the user generic MAP indication element. The content of the user specific MAP indication element may thus vary depending on the cooperation scheme to be utilized. The information included in the user specific MAP indication element may for example include transmit parameters or relate to specific protocol aspects. The user specific MAP indication element may identify the cooperation scheme to be utilized. For this purpose, the user specific MAP indication element may include a cooperation scheme identifier of the cooperation scheme. If more than one associated STA shall participate in the transmissions which are coordinated based on the selected cooperation scheme, the MAP coordination user indication may include multiple user specific MAP indication elements, each relating to another associated STA. The respective STA may be indicated by a STA identifier included in the user specific MAP indication element.

The above exemplary formats may also help to achieve forward compatibility. Specifically, if a new cooperation scheme is introduced, this new cooperation scheme can be identified by the corresponding identifier included in the specific MAP indication element, specific MAP response element, and user specific MAP indication element. If an older AP or STA receives such specific information element relating to an unknown cooperation scheme, the older AP or STA can skip that specific information element in processing and merely consider those specific information elements which are known. As a result, a potential shared AP would also not provide feedback for a cooperation scheme which is unknown to the potential shared AP.

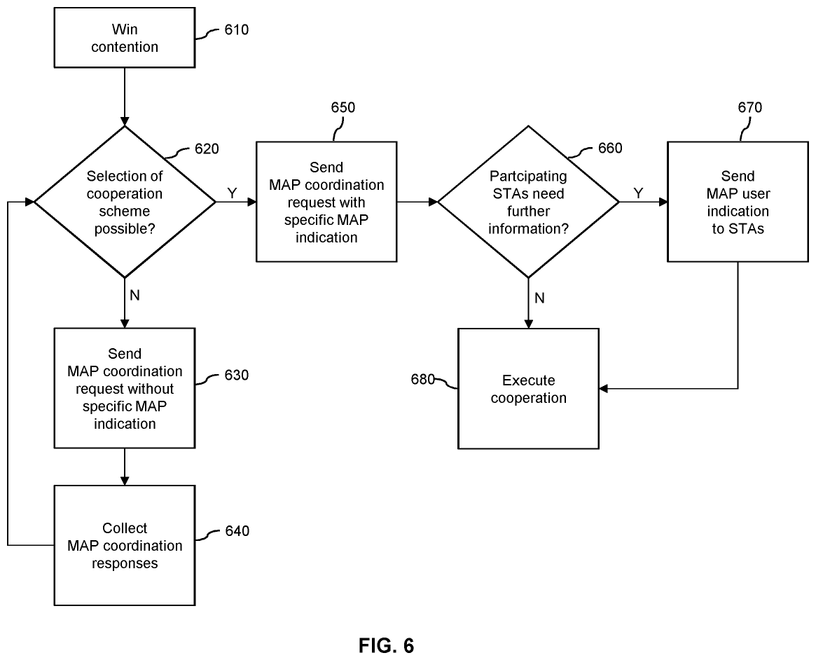

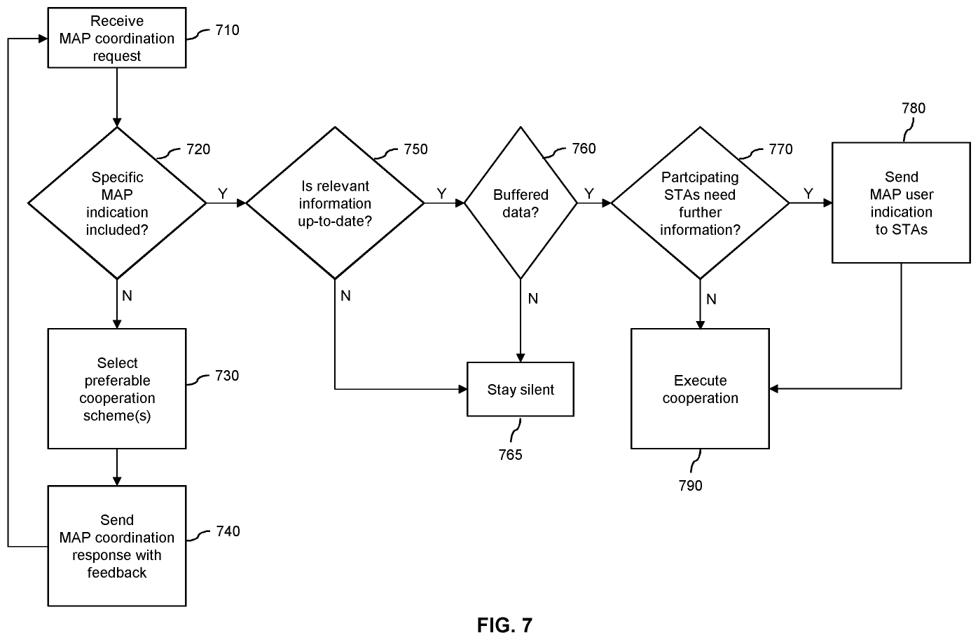

In the following, examples of implementing the versatile setup procedure will be explained in more detail, with FIG. 6 illustrating operations performed by a sharing AP and FIG. 7 illustrating operations performed by a shared AP. Here, it is noted that the sharing AP performing the operations of FIG. 6 could interact and cooperate with multiple shared APs performing the operations of FIG. 7. The sharing AP and the shared AP(s) could for example correspond to any of the APs illustrated in FIG. 2.

Referring to FIG. 6, at some point an AP wins contention for a TXOP on the wireless medium, as illustrated by block 610. After winning contention for the TXOP, the AP decides to coordinate usage with the TXOP with other APs, by allowing one or more other APs to share the TXOP. The AP winning the TXOP thus becomes a sharing AP.

The sharing AP then attempts to select a cooperation scheme to be utilized for the TXOP, by first checking if it is possible for the sharing AP to make the selection, as illustrated by block 620. This check can for example be based on whether the sharing AP has sufficient or sufficiently up-to-date information to make the selection. In some cases, the information being sufficient can also mean that the sharing AP knows that at least some of the potential shared APs support only one cooperation scheme. If making the decision is not possible, as indicated by branch “N”, the sharing AP proceeds to block 630 and sends a MAP coordination request to one or more potential shared APs, e.g., to neighboring APs. The MAP coordination request indicates a set of one or more cooperation schemes supported by the sharing AP, and which are deemed to be candidates to be utilized for the present TXOP. These cooperation schemes of interest are indicated in the MAP control field of the MAP coordination request, and generic information for these cooperation schemes of interest can be indicated in the generic MAP indication element of the MAP coordination request. The MAP coordination request does not include a specific MAP indication element and thus indicates to the potential shared AP(s) that the sharing AP has not yet selected a cooperation scheme to be utilized and that the potential shared AP(s) should provide feedback on the cooperation schemes of interest indicated in the MAP coordination request. After sending the MAP coordination request, the sharing AP collects feedback received in one or more MAP coordination responses from the potential shared APs. The sharing AP may then return to block 620 to check if selection of a cooperation scheme is now possible with the collected feedback. The processes of blocks 620, 630, and 640 can in principle be iterated as often as needed to collect sufficient information. However, in most practical scenarios no more than one iteration is needed.

If at block 620 selection of a cooperation scheme to be utilized for the TXOP is possible, as indicated by branch “Y”, the sharing AP selects the cooperation scheme and continues by sending further MAP coordination request to the potential shared APs, as indicated by block 650. This further MAP coordination request also includes a specific MAP indication element for the selected cooperation scheme. The specific MAP indication element for example indicates transmission parameters for the selected cooperation scheme.

As indicated by block 660, the sharing AP then checks if the associated STAs which are intended to participate in the coordinated usage of the TXOP need further information. If this is the case, as indicated by branch “Y”, the sharing AP sends a MAP user indication to these associated STAs, as indicated by block 670. The MAP user indication informs the STAs about the cooperation scheme to be utilized, transmissions parameters, and other relevant information. Whether providing such information to the STAs is needed typically depends on the cooperation scheme to be utilized and on whether the cooperation relates to downlink transmission or uplink transmission. For example, providing such information to the STAs is typically required in cooperation schemes for uplink transmissions, but also in some cooperation schemes for downlink transmissions, such as C-OFDMA.

After sending the MAP user indication, the sharing AP can start with execution of the cooperation based on the selected cooperation scheme in the TXOP, as indicated by block 680. If the check of block 660 yields that providing further information to the STAs is not necessary, as indicated by branch “N”, the sharing AP can also immediately proceed to block 680 and start execution of the cooperation in the TXOP, without first sending a MAP user indication to the STAs.

Referring to FIG. 7, at some point an AP receives a MAP coordination request from another AP, as indicated by block 710. The other AP may for example be the sharing AP operating as explained in connection with FIG. 6. The MAP coordination request indicates that the other AP is interested in cooperating in using a TXOP. The AP thus becomes a potential shared AP for this TXOP.

As indicated by block 720, the potential shared AP checks if the received MAP coordination request includes a specific MAP indication element. If this is not the case, as indicated by branch “N”, the potential shared AP concludes that the sharing AP still has to select a cooperation scheme to be utilized for the TXOP. As indicated by block 730, the potential shared AP may then itself select one or more cooperation schemes which are preferable from the perspective of the potential shared AP. The potential shared AP may select the preferable cooperation scheme(s) from a set of one or more cooperation schemes of interest, indicated in the MAP control field of the MAP coordination request. In some scenarios, the sharing AP may indicated these one or more cooperation schemes of interest to trigger feedback from the potential shared AP on such cooperation scheme(s). As indicated by block 740, the potential shared AP then sends a MAP coordination response to the sharing AP, indicating feedback on the preferred cooperation schemes. The potential shared AP may then return to block 710 and receive a further MAP coordination request from the sharing AP. This processes of blocks 710, 720, 730, and 740 can in principle be iterated as often as needed to collect sufficient information. However, in most practical scenarios no more than one iteration is needed.

If the check of block 720 yields that the received MAP coordination request includes a specific MAP indication element, as indicated by branch “Y”, the potential shared AP concludes that the sharing AP has selected a cooperation scheme to be utilized in the TXOP, namely the cooperation scheme indicated by the specific MAP indication. The potential shared AP then continues to block 750, to check if it has sufficient and/or sufficiently up-to-date information collected to participate in the selected cooperation scheme. If that is the case, as indicated by branch “Y”, the potential sharing AP can further check if it has data to transmit in its buffer(s) or that the amount of data to transmit in the buffer is above a threshold, so that a transmission with an excessive amount of padding can be avoided. If the check of block 750 yields that there potential shared AP does not have sufficient or sufficiently up-to-date information, or the check of block 760 yields that there is not sufficient buffered data to transmit, as indicated by branches “N”, the potential shared AP stays silent, i.e., does not respond or otherwise further react to the MAP coordination request, as indicated by block 765.

If the check of block 750 yields that the potential shared AP has sufficient and sufficiently up-to-date information, and the check of block 760 yields that there is sufficient buffered data to transmit, as indicated by branches “Y”, the potential shared AP may decide to participate in the cooperation and thus becomes a shared AP. The shared AP may then proceed to block 770, to check if the associated STAs which are intended to participate in the coordinated usage of the TXOP need further information. If this is the case, as indicated by branch “Y”, the shared AP sends a MAP user indication to these associated STAs, as indicated by block 780. The MAP user indication informs the STAs about the cooperation scheme to be utilized, transmissions parameters, and other relevant information. Whether providing such information to the STAs is needed typically depends on the cooperation scheme to be utilized and on whether the cooperation relates to downlink transmission or uplink transmission. For example, providing such information to the STAs is typically required in cooperation schemes for uplink transmissions, but also in some cooperation schemes for downlink transmissions, such as C-OFDMA.

After sending the MAP user indication, the shared AP can start with execution of the cooperation based on the selected cooperation scheme in the TXOP, as indicated by block 790. If the check of block 770 yields that providing further information to the STAs is not necessary, as indicated by branch “N”, the shared AP can also immediately proceed to block 790 and start execution of the cooperation in the TXOP, without first sending a MAP user indication to the STAs.

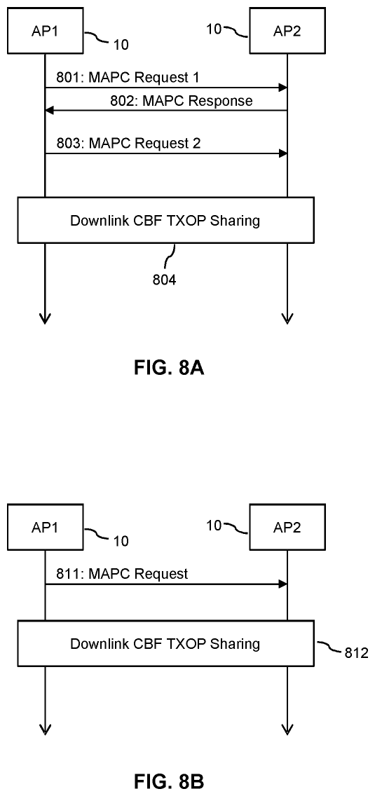

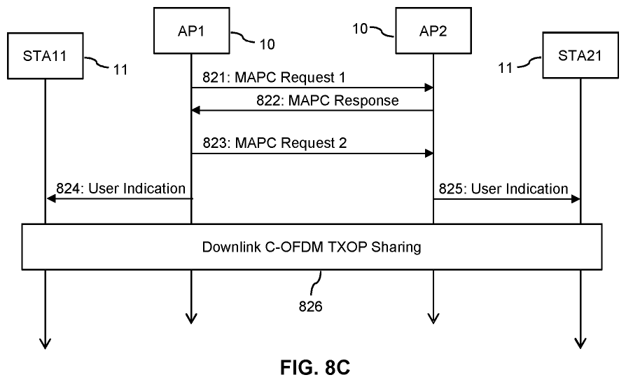

In the following exemplary processes of utilizing the versatile setup procedure of the illustrated concepts will be further explained by referring to exemplary scenarios illustrated by FIGS. 8A, 8B, and 8C. Each scenario involves a first AP (AP1), which is assumed to be the sharing AP, and a second AP (AP2), which is assumed to be the shared AP. It is however noted that there could also be multiple shared APs, which would then operate in a corresponding manner as explained for AP2. The sharing AP and the shared APs could be part of an AP candidate set and could for example correspond to some of the APs 10 illustrated in FIG. 2.

In the scenario of FIG. 8A, it is assumed that AP1 and AP2 have not yet cooperated in usage of a TXOP, or that a longer time has elapsed since AP1 and AP2 last cooperated in usage of a TXOP. Accordingly, when winning contention for a TXOP, AP1 does not have all relevant information, or at least not sufficiently up-to-date information, to decide which cooperation scheme is the most appropriate to use in the TXOP. After winning the TXOP, AP1 thus starts the setup procedure by sending a MAP coordination (MAPC) request 801 to AP2 (and possibly other potential shared APs). The MAPC request 801 indicates that AP1 is willing to share the TXOP using any from a set of cooperation schemes of interest, indicated in the MAPC request 801. The MAPC request 801 does not include a specific MAP indication element. Accordingly, from the received MAPC request 801, AP2 (and any other potential shared AP) knows that the setup procedure will include further messages, typically two or three further messages, and that AP1 wants feedback on the cooperation scheme(s) of interest indicated in the MAPC request 801. AP2 then responds by a MAPC response 802 to AP1. The MAPC response 802 includes the requested feedback information. As explained above, the MAPC response 802 may include a generic MAP response element with feedback information common to the indicated cooperation schemes of interest. Further, the MAPC response 802 may include a respective specific MAP response element for at least one of the indicated cooperation schemes of interest.

Based on the information collected from the MAPC response 802, AP1 now has the information needed to select the cooperation scheme to be utilized in the TXOP. In the example of FIG. 8A, it is assumed that AP1 and AP2 have plenty of data to be transmitted in their buffers and that there are no significant differences on the latency requirements of the buffered data in each BSS. In view of this situation, AP1 decides to utilize CBF for downlink transmissions, i.e., downlink CBF TXOP sharing, as cooperation scheme for the TXOP. This selection made by AP1 can be expected to provide an increase in system throughput, however at the cost of some overhead due to a required sounding process.

Having made the selection, AP1 sends a further MAPC request 803 to AP2. The further MAPC request 803 includes a specific MAP indication element corresponding to downlink CBF. The specific MAP indication element may indicate which target STAs shall be considered in the sounding process. Further, the specific MAP indication element could also indicate which type of sounding process shall be used. Since in the selected cooperation scheme there is no need to provide further information to the participating STAs, execution of the downlink CBF TXOP sharing can start after transmission of the further MAPC request 803, without requiring any further message exchange between AP1 and AP2. Execution of the downlink CBF TXOP sharing is indicated by block 804.

The scenario of FIG. 8B is assumed to be generally similar to that of FIG. 8A, however assuming that, when winning the contention for a TXOP, AP1 already has all relevant and sufficiently up-to-date information to decide which cooperation scheme is the most appropriate to use in the TXOP. Accordingly, AP1 may directly select CBF for downlink transmissions, i.e., downlink CBF TXOP sharing, as the cooperation scheme to be utilized. AP1 then starts the setup procedure by sending a MAPC request 811 to AP2 (and possibly other potential shared APs). The MAPC request 811 indicates that AP1 is willing to share the TXOP and includes a specific MAP indication element corresponding to downlink CBF. Having received the MAPC request 811, AP2 may thus conclude that there will be no further messages in the setup procedure and that execution of the downlink CBF cooperation can start immediately using the transmission parameters and other information indicated in the MAP specific indication of the MAPC request 811. Execution of the downlink CBF TXOP sharing is indicated by block 812.

The scenario of FIG. 8C is assumed to be generally similar to that of FIG. 8A, however assuming that the traffic requirements at AP1 are somewhat different. For example, AP1 may have recently buffered data for transmission which have a strict latency requirement.

When winning contention for a TXOP, AP1 does not have all relevant information, or at least not sufficiently up-to-date information, to decide which cooperation scheme is the most appropriate to use in the TXOP. After winning the TXOP, AP1 thus starts the setup procedure by sending a MAPC request 821 to AP2 (and possibly other potential shared APs). The MAPC request 821 indicates that AP1 is willing to share the TXOP using any from a set of cooperation schemes of interest, indicated in the MAPC request 801. However, downlink CBF TXOP sharing is excluded from this set, because AP1 expects that the required sounding process could result in non-compliance with the latency requirement of the buffered data. The MAPC request 821 does not include a specific MAP indication element. Accordingly, from the received MAPC request 821, AP2 (and any other potential shared AP) knows that the setup procedure will include further messages, typically two or three further messages, and that AP1 wants feedback on the cooperation scheme(s) of interest indicated in the MAPC request 821. AP2 then responds by a MAPC response 822 to AP1. The MAPC response 822 includes the requested feedback information. As explained above, the MAPC response 822 may include a generic MAP response element with feedback information common to the indicated cooperation schemes of interest. Further, the MAPC response 822 may include a respective specific MAP response element for at least one of the indicated cooperation schemes of interest.

Based on the information collected from the MAPC response 822, AP1 now has the information needed to select the cooperation scheme to be utilized in the TXOP. In the example of FIG. 8C, it is assumed that AP1 decides to utilize C-OFDM for downlink transmissions, i.e., downlink C-OFDM TXOP sharing, as cooperation scheme for the TXOP.

Having made the selection, AP1 sends a further MAPC request 823 to AP2. The further MAPC request 823 includes a specific MAP indication element corresponding to downlink CBF TXOP sharing. From this information, AP2 (and any other shared AP) will know that also the associated STAs, which are intended to participate, need to be provided with further information, e.g., a respective frequency allocation. Accordingly, in the scenario of FIG. 8C, AP2 then sends a MAPC user indication 824 to its associated STAs (represented by STA21). Similarly, AP1 sends a MAPC user indication 825 to its associated STAs (represented by STA11). The MAPC user indications 824, 825 provide the participating STAs with the respective relevant information for participating in the downlink C-OFDMA TXOP sharing, such as frequency allocation.

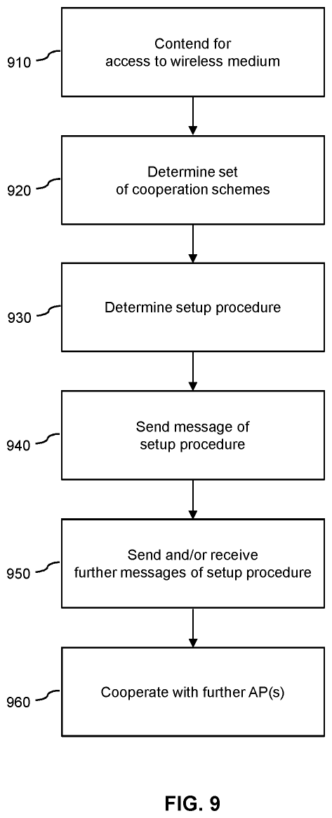

FIG. 9 shows a flowchart for illustrating a method, which may be utilized for implementing the illustrated concepts. The method of FIG. 9 may be used for implementing the illustrated concepts in an AP of a wireless communication system. This AP may for example correspond to a sharing AP of the above-described examples. The AP may correspond to one of the above-mentioned APs 10. The wireless communication system may be based on a wireless local area network, WLAN, technology, e.g., according to the IEEE 802.11 standards family.

If a processor-based implementation of the AP is used, at least some of the steps of the method of FIG. 9 may be performed and/or controlled by one or more processors of the AP. Such AP may also include a memory storing program code for implementing at least some of the below described functionalities or steps of the method of FIG. 9.

At step 910, the AP may contend for access to a wireless medium. This may involve performing a CCA (clear channel assessment) or LBT (listen before talk) procedure to assess whether the wireless medium is occupied. In some cases, the AP may win contention for the wireless medium and reserve a TXOP on the wireless medium. In such cases, the AP may be referred to as TXOP owner. In other scenarios, another AP may win the contention for access to the wireless medium. In such cases, the other AP may reserve a TXOP on the wireless medium and the other AP would be the TXOP owner.

At step 920, the AP determines a set of one or more cooperation schemes for cooperating with one or more further APs of the wireless communication system. The one or more cooperation schemes comprise a cooperation scheme based on C-OFDMA, a cooperation scheme based on C-TDMA, a cooperation scheme based on CSR, a cooperation scheme based on CBF, and/or a cooperation scheme based on JT by two or more APs. It is however noted that other cooperation schemes could be considered in addition or as an alternative.

At step 930, the AP determines a setup procedure for setting up cooperation among at least the AP and the one or more further APs based on a cooperation scheme selected from the set of one or more cooperation schemes. Here, it is noted that the selection of the cooperation scheme may also be accomplished during the setup procedure.

The set of one or more cooperation schemes may include at least two cooperation schemes which differ with respect to a number of further messages to be exchanged between the AP and the at least one of the one or more further access points in the setup procedure. For at least one of the one or more cooperation schemes a number of messages of the setup procedure transmitted from the AP to the at least one of the one or more further APs is one, e.g., as in the example of FIG. 8B. Further, for at least one of the one or more cooperation schemes a number of messages of the setup procedure transmitted from the AP to the at least one of the one or more further APs is two, e.g., as in the example of FIG. 8A or 8C.

At step 940, the AP sends a message of the setup procedure to the one or more further APs. The message indicates a further part of the setup procedure. The message can be an initial message of the setup procedure, e.g., the message transmitted first after winning the TXOP. The message may then also indicate the reservation of the TXOP by the AP. The above-mentioned MAP coordination request is an example of such message. In the MAP coordination request the presence of the MAP specific indication element indicates whether the sharing AP expects feedback and, thus, further messages of the setup procedure will need to be sent or received. Such further messages can be sent or received at step 950.

In some scenarios, the message sent at step 940 may indicate whether the further part of the setup procedure requires a response to the message. Alternatively or in addition, the message sent at step 940 may indicate a number of messages to be exchanged between the AP and the at least one of the one or more further APs in the setup procedure. Such indication may be explicit, e.g., in the form of a number, or may be implicit, i.e., derivable from other information included in the message.

In some scenarios, the message sent at step 940 may indicate the selected cooperation scheme, e.g., as in the example of FIG. 8B, where the MAPC request 811 already indicates the selected cooperation scheme to be utilized. In other scenarios, the message sent at step 940 may indicate a suggested cooperation scheme, such as the cooperation schemes of interest that are indicated in the MAPC request 801 in the example of FIG. 8A or in the MAPC request 821 in the example of FIG. 8C.

In some scenarios, a further message transmitted by the AP in the further part of the setup procedure may indicate the selected cooperation scheme, such as in the examples of FIGS. 8A and 8C, where the further MAPC request 803, 823 indicates the selected cooperation scheme to be utilized. Such further message may be sent to at least one of the one or more further APs.

In some scenarios, a further message received by the AP in the further part of the setup procedure indicates at least one suggested cooperation scheme. Such further message may be received from one or more of the further APs and indicate one or more cooperation schemes which are preferred from the perspective of the further AP.

In some scenarios, the message transmitted at step 940 or a further message transmitted by the AP in the further part of the setup procedure, e.g., in step 950, indicates whether the selected cooperation scheme applies to downlink transmission, uplink transmission, or both downlink and uplink transmission.

At step 960, based on the setup procedure and the selected cooperation scheme, the access point cooperates with at least one of the one or more further APs in using the TXOP. The cooperation in using the TXOP may involve sharing the TXOP, i.e.. allowing that resources of the TXOP are used by the cooperating APs for sending or receiving wireless transmissions. In some cases, the cooperation in using the TXOP may also involve joint transmissions by two or more of the cooperating APs. In this case, the respective other AP could assist the AP in performing its own transmission. Such assistance can also be mutual between at least some of the cooperating APs.

In some scenarios, the method of FIG. 9 may also involve that the AP sends an indication of a capability of the AP to at least one of the one or more further APs, with the cooperation of step 960 being based on this capability of the AP. In addition or as an alternative, the AP could receive, from at least one of the one or more further APs, a respective indication of a capability of the further AP, with the cooperation of step 960 being based on this capability of the further AP. Such exchange of capability indications may be performed before the TXOP is reserved and may for example be based on one or more beacons transmitted by the AP and the further AP(s), such as in the first phase illustrated in FIG. 1.

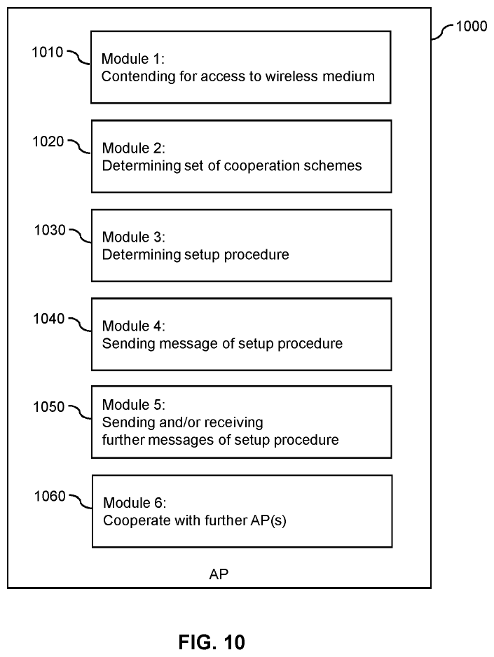

FIG. 10 shows a block diagram for illustrating functionalities of an AP 1000 which operates according to the method of FIG. 9. The AP 1000 may for example correspond to one of above-mentioned APs 10. As illustrated, the AP 1000 may be provided with a module 1010 configured to contend for access to a wireless medium, such as explained in connection with step 1010. Further, the AP 1000 may be configured with a module 1020 configured to determine a set of one or more cooperation schemes, such as explained in connection with step 920. Further, the AP 1000 may be provided with a module 1030 configured to determine a setup procedure, such as explained in connection with step 930. Further, the AP 1000 may be provided with a module 1040 configured to send a message of the setup procedure, such as explained in connection with step 940. Further, the AP 1000 may be provided with a module 1050 configured to send and/or receive one or more further messages of the setup procedure, such as explained in connection with step 950. Further, the AP 1000 may be provided with a module 1060 configured to cooperate with one or more further APs, such as explained in connection with step 960.

It is noted that the AP 1000 may include further modules for implementing other functionalities, such as known functionalities of an AP in an IEEE 802.11 technology. Further, it is noted that the modules of the AP 1000 do not necessarily represent a hardware structure of the AP 1000, but may also correspond to functional elements, e.g., implemented by hardware, software, or a combination thereof.

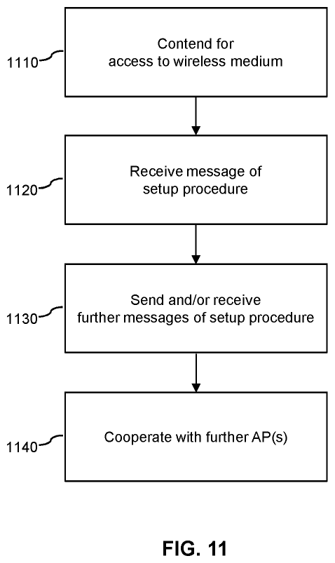

FIG. 11 shows a flowchart for illustrating a method, which may be utilized for implementing the illustrated concepts. The method of FIG. 11 may be used for implementing the illustrated concepts in an AP of a wireless communication system. This AP may for example correspond to a potential shared AP of the above-described examples. The AP may correspond to one of the above-mentioned APs 10. The wireless communication system may be based on a wireless local area network, WLAN, technology, e.g., according to the IEEE 802.11 standards family.

If a processor-based implementation of the AP is used, at least some of the steps of the method of FIG. 11 may be performed and/or controlled by one or more processors of the AP. Such AP may also include a memory storing program code for implementing at least some of the below described functionalities or steps of the method of FIG. 11.

At step 1110, the AP may contend for access to a wireless medium. This may involve performing a CCA or LBT procedure to assess whether the wireless medium is occupied. In some cases, the AP may win contention for the wireless medium and reserve a TXOP on the wireless medium. In such cases, the AP may be referred to as TXOP owner. In other scenarios, another AP may win the contention for access to the wireless medium. In such cases, the other AP may reserve a TXOP on the wireless medium and the other AP would be the TXOP owner.

At step 1120, the AP receives, from a further AP, a message of a setup procedure for setting up cooperation among at least the AP and the further AP based on a cooperation scheme selected from a set of one or more cooperation schemes. The message received at step 1120 indicates a further part of the setup procedure. The message can be an initial message of the setup procedure, e.g., the message transmitted first after winning the TXOP. The message may then also indicate the reservation of the TXOP by the further AP. The above-mentioned MAP coordination request is an example of such message. In the MAP coordination request the presence of the MAP specific indication element indicates whether the sharing AP expects feedback and, thus, further messages of the setup procedure will need to be sent or received. Such further messages can be sent or received at step 1130.

In some scenarios, the message received at step 1120 may indicate whether the further part of the setup procedure requires a response to the message. Alternatively or in addition, the message received at step 1120 may indicate a number of messages to be exchanged between the AP and the further AP in the setup procedure. Such indication may be explicit, e.g., in the form of a number, or may be implicit, i.e., derivable from other information included in the message.

In some scenarios, the message received at step 1120 may indicate the selected cooperation scheme, e.g., as in the example of FIG. 8B, where the MAPC request 811 already indicates the selected cooperation scheme to be utilized. In other scenarios, the message received at step 1120 may indicate a suggested cooperation scheme, such as the cooperation schemes of interest that are indicated in the MAPC request 801 in the example of FIG. 8A or in the MAPC request 821 in the example of FIG. 8C.

In some scenarios, a further message received by the AP in the further part of the setup procedure may indicate the selected cooperation scheme, such as in the examples of FIGS. 8A and 8C, where the further MAPC request 803, 823 indicates the selected cooperation scheme to be utilized. Such further message may be received from the further AP.

In some scenarios, a further message sent by the AP in the further part of the setup procedure indicates at least one suggested cooperation scheme. Such further message may be sent to the further AP and indicate one or more cooperation schemes which are preferred from the perspective of the AP.

In some scenarios, the message received at step 1120 or a further message received by the AP in the further part of the setup procedure, e.g., in step 1130, indicates whether the selected cooperation scheme applies to downlink transmission, uplink transmission, or both downlink and uplink transmission.

At step 1140, based on the setup procedure and the selected cooperation scheme, the access point cooperates with at least the further AP in using the TXOP. The cooperation in using the TXOP may involve sharing the TXOP, i.e.. allowing that resources of the TXOP are used by the cooperating APs for sending or receiving wireless transmissions. In some cases, the cooperation in using the TXOP may also involve joint transmissions by two or more of the cooperating APs. In this case, the AP could assist the further AP in performing its own transmission. Such assistance can also be mutual between at least some of the cooperating APs.

In some scenarios, the method of FIG. 11 may also involve that the AP sends an indication of a capability of the AP to the further AP, with the cooperation of step 1140 being based on this capability of the AP. In addition or as an alternative, the AP could receive, from the further AP, a respective indication of a capability of the further AP, with the cooperation of step 1140 being based on this capability of the further AP. Such exchange of capability indications may be performed before the TXOP is reserved and may for example be based on one or more beacons transmitted by the AP and the further AP, such as in the first phase illustrated in FIG. 1.

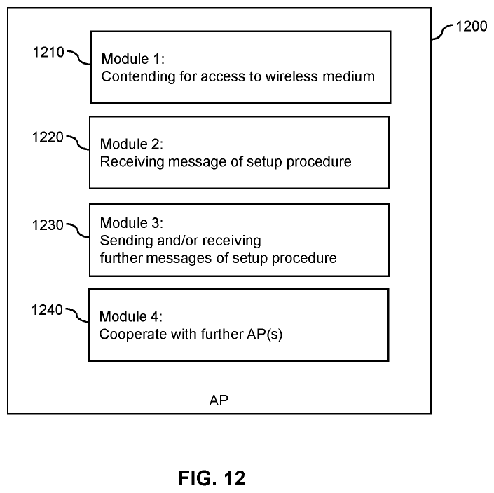

FIG. 12 shows a block diagram for illustrating functionalities of an AP 1200 which operates according to the method of FIG. 11. The AP 1200 may for example correspond to one of above-mentioned APs 10. As illustrated, the AP 1200 may be provided with a module 1210 configured to contend for access to a wireless medium, such as explained in connection with step 1210. Further, the AP 1200 may be configured with a module 1220 configured to receive a message of the setup procedure, such as explained in connection with step 1120. Further, the AP 1200 may be provided with a module 1230 configured to send and/or receive one or more further messages of the setup procedure, such as explained in connection with step 1130. Further, the AP 1200 may be provided with a module 1240 configured to cooperate with one or more further APs, such as explained in connection with step 1140.

It is noted that the AP 1200 may include further modules for implementing other functionalities, such as known functionalities of an AP in an IEEE 802.11 technology. Further, it is noted that the modules of the AP 1200 do not necessarily represent a hardware structure of the AP 1200, but may also correspond to functional elements, e.g., implemented by hardware, software, or a combination thereof.

It is noted that in the method of FIG. 9, the AP performing the method can be regarded as being responsible for managing the setup procedure, because determines the configuration of setup procedure and also determines the set of cooperation scheme used as input for the selection. The one or more further APs may then each operated according to the method of FIG. 11. It is noted that such role does not need to be fixedly assigned to a certain AP, but can vary. For example, the AP winning the TXOP could then also be responsible for managing the setup procedure for any possible cooperation in this TXOP. In some scenarios, the illustrated concepts may also be implemented in a system which includes an AP operating according to the method of FIG. 9 and one or more further APs operating according to the method of FIG. 11. Such system could also include one or more STAs associated to a respective one of the cooperating APs.

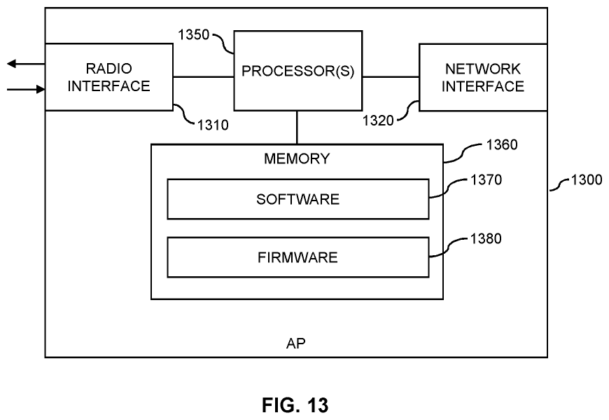

FIG. 13 illustrates a processor-based implementation of an AP 1300. The structures as illustrated in FIG. 13 may be used for implementing the above-described concepts. The AP 1300 may for example correspond to one of above-mentioned APs 10.

As illustrated, the AP 1300 includes a radio interface 1310. The radio interface 1310 may for example be based on a WLAN technology, e.g., according to an IEEE 802.11 family standard. However, other wireless technologies could be supported as well, e.g., the LTE technology or the NR technology. In some cases, the radio interface 1310 may comprise multiple transmit and receive processing chains. In some scenarios, the radio interface 1310 may be based on multiple antennas of the AP 1300 and support beamformed multi-antenna port transmission and/or reception to enable spatial multiplexing of wireless transmissions, i.e., usage of multiple spatial streams. Further, the AP 1300 is provided with a network interface 1320 for connecting to a data network, e.g., using a wire-based connection.

Further, the AP 1300 may include one or more processors 1350 coupled to the interfaces 1310, 1320 and a memory 1360 coupled to the processor(s) 1350. By way of example, the interfaces 1310, 1320, the processor(s) 1350, and the memory 1360 could be coupled by one or more internal bus systems of the AP 1300. The memory 1360 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1360 may include software 1370 and/or firmware 1380. The memory 1360 may include suitably configured program code to be executed by the processor(s) 1350 so as to implement the above-described functionalities for controlling wireless transmissions, such as explained in connection with FIG. 9 or 11.

It is to be understood that the structures as illustrated in FIG. 13 are merely schematic and that the AP 1300 may actually include further components which, for the sake of clarity, have not been illustrated, e.g., further interfaces or further processors. Also, it is to be understood that the memory 1360 may include further program code for implementing known functionalities of an AP in an IEEE 802.11 technology. According to some embodiments, also a computer program may be provided for implementing functionalities of the AP 1300, e.g., in the form of a physical medium storing the program code and/or other data to be stored in the memory 1360 or by making the program code available for download or by streaming.

As can be seen, the concepts as described above may be used for efficiently managing cooperation among APs in scenarios where multiple different cooperation schemes are available for utilization. In this way, selection of the cooperation scheme can be made in a dynamic manner and in a case-by-case basis, with the possibility to vary the utilized cooperation scheme between TXOPs. As a result, performance and/or resource efficiency of the wireless communication system can be improved.

It is to be understood that the examples and embodiments as explained above are merely illustrative and susceptible to various modifications. For example, the illustrated concepts are not limited with respect to the number of parallel incoming and outgoing wireless transmissions. Further, the illustrated concepts may be applied in connection with various kinds of wireless technologies, without limitation to WLAN technologies. Further, the concepts may be applied with respect to various types and numbers of cooperating APs. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1.-36. (canceled)

37. A method of controlling wireless transmissions in a wireless communication system, the method being performed by an access point of the wireless communication system, the method comprising:
determining a set of one or more cooperation schemes for cooperating with one or more further access points of the wireless communication system;
determining a setup procedure for setting up cooperation among at least the access point and the one or more further access points based on a cooperation scheme selected from the set of one or more cooperation schemes;
sending a message of the setup procedure to the one or more further access points, the message indicating a further part of the setup procedure; and
based on the setup procedure and the selected cooperation scheme, cooperating with at least one of the one or more further access points in using a transmission opportunity (TXOP) on a wireless medium.

38. The method according to claim 37, wherein the message indicates one or more of the following:
whether the further part of the setup procedure requires a response to the message; and
a number of further messages to be exchanged between the access point and the at least one of the one or more further access points in the setup procedure.

39. The method according to claim 37, wherein the set of one or more cooperation schemes includes at least two cooperation schemes which differ with respect to a number of messages to be exchanged between the access point and the at least one of the one or more further access points during the setup procedure.

40. The method according to claim 37, wherein one or more of the following applies:
for at least one of the one or more cooperation schemes, a number of messages of the setup procedure transmitted from the access point to the at least one of the one or more further access points is one; and
for at least one of the one or more cooperation schemes, a number of messages of the setup procedure transmitted from the access point to the at least one of the one or more further access points is two.

41. The method according to claim 37, wherein the message indicates one of the following: the selected cooperation scheme, or at least one suggested cooperation scheme.

42. The method according to claim 37, wherein a further message transmitted by the access point in the further part of the setup procedure indicates one of the following: the selected cooperation scheme, or at least one suggested cooperation scheme.

43. The method according to claim 37, wherein one of the following indicates whether the selected cooperation scheme applies to downlink transmission, uplink transmission, or both downlink and uplink transmission: the message, or a further message transmitted by the access point in the further part of the setup procedure

44. The method according to claim 37, wherein the one or more cooperation schemes include one or more of the following:
a cooperation scheme based on coordinated time division multiple access,
a cooperation scheme based on coordinated orthogonal frequency division multiple access,
a cooperation scheme based on coordinated spatial reuse,
a cooperation scheme based on coordinated beamforming, and
a cooperation scheme based on joint transmission by two or more access points.

45. The method according to claim 37, further comprising one or more of the following
sending an indication of a capability of the access point to at least one of the one or more further access points, wherein the cooperating in using the TXOP is based on the capability of the access point; and
receiving, from at least one of the one or more further access points, respective indications of respective capabilities of the at least one further access point, wherein said cooperating in using the TXOP is based on the respective capabilities of the at least one further access point.

46. A method of controlling wireless transmissions in a wireless communication system, the method being performed by an access point of the wireless communication system, the method comprising:
receiving, from a further access point of the wireless communication system, a message of a setup procedure for setting up cooperation among at least the access point and the further access point based on a cooperation scheme selected from a set of one or more cooperation schemes, wherein the message indicates a further part of the setup procedure; and
based on the setup procedure and the selected cooperation scheme, cooperating at least with the further access point in using a transmission opportunity (TXOP) on a wireless medium.

47. The method according to claim 46, wherein the message indicates one or more of the following:
whether the further part of the setup procedure requires a response to the message; and
a number of further messages to be exchanged between the access point and the at least one of the one or more further access points during the setup procedure.

48. The method according to claim 46, wherein the set of one or more cooperation schemes includes at least two cooperation schemes which differ with respect to a number of messages to be exchanged between the access point and the at least one of the one or more further access points during the setup procedure.

49. The method according to claim 46, wherein one or more of the following applies:
for at least one of the one or more cooperation schemes, a number of messages of the setup procedure transmitted from the access point to the at least one of the one or more further access points is one; and
for at least one of the one or more cooperation schemes, a number of messages of the setup procedure transmitted from the access point to the at least one of the one or more further access points is two.

50. The method according to claim 46, wherein the message indicates one of the following: the selected cooperation scheme, or at least one suggested cooperation scheme.

51. The method according to claim 46, wherein one of the following applies:
a further message received from the further access point in the further part of the setup procedure indicates the selected cooperation scheme; or
a further message sent to the further access point in the further part of the setup procedure indicates at least one suggested cooperation scheme.

52. The method according to claim 46, wherein one of the following indicates whether the selected cooperation scheme applies to downlink transmission, uplink transmission, or both downlink and uplink transmission: the message, or a further message received from the further access point in the further part of the setup procedure.

53. The method according to claim 46, wherein the one or more cooperation schemes include one or more of the following:
a cooperation scheme based on coordinated time division multiple access,
a cooperation scheme based on coordinated orthogonal frequency division multiple access,
a cooperation scheme based on coordinated spatial reuse,
a cooperation scheme based on coordinated beamforming, and
a cooperation scheme based on joint transmission by two or more access points.

54. The method according to claim 46, further comprising one or more of the following:
receiving, from the further access point, an indication of a capability of the further access point, wherein cooperating in using the TXOP is based on the capability of the further access point; and
sending, to the further access point, an indication of a capability of the access point, wherein cooperating in using the TXOP is based on the capability of the further access point.

55. An access point for a wireless communication system, the access point comprising:
at least one processor; and
a memory containing program code executable by the at least one processor, wherein execution of the program code by the at least one processor causes the access point to:
determine a set of one or more cooperation schemes for cooperating with one or more further access points of the wireless communication system;
determine a setup procedure for setting up cooperation based on a cooperation scheme selected from the set of one or more cooperation schemes;
send a message of the setup procedure to the one or more further access points, the message indicating a further part of the setup procedure; and
based on the setup procedure and the selected cooperation scheme, cooperate with at least one of the one or more further access points in using a transmission opportunity (TXOP) on a wireless medium.

56. An access point for a wireless communication system, the access point comprising:
at least one processor; and
a memory containing program code executable by the at least one processor, wherein execution of the program code by the at least one processor causes the access point to perform the method of claim 46.
